(19) United States
(12) Patent Application Publication
(10) Pub. No.: US 2025/0252695 A1
(43) Pub. Date: Aug. 7, 2025

(54) OPERATING APPARATUS, INFORMATION PROCESSING APPARATUS, INFORMATION PROCESSING SYSTEM, INFORMATION PROCESSING METHOD, AND INFORMATION PROCESSING PROGRAM

(71) Applicant: Sony Interactive Entertainment Inc., Tokyo (JP)

(72) Inventor: Takuya Kuji, Tokyo (JP)

(73) Assignee: Sony Interactive Entertainment Inc., Tokyo (JP)

(21) Appl. No.: 18/855,377

(22) PCT Filed: Apr. 26, 2022
(86) PCT No.: PCT/JP2022/018937

§ 371 Date: Oct. 9, 2024

(51) Int. Cl. G06T 19/20; G06T 7/40; G06T 7/50; G06T 7/73

(52) U.S. Cl. CPC G06T 19/20; G06T 7/40; G06T 7/50; G06T 7/74; G06T 2200/08; G06T 2200/24; G06T 2207/30196; G06T 2219/2021

(57) ABSTRACT

An operating apparatus is an operating apparatus configured to receive an operation performed by a user and includes a detection unit configured to detect the operation, an acquisition unit configured to acquire a first image in which a hand of the user is captured, a feature information generation unit configured to generate feature information regarding the hand on the basis of the first image, and a feature information output unit configured to output a detection result obtained by the detection unit and the feature information.

### TECHNICAL FIELD

The present invention relates to an operating apparatus, an information processing apparatus, an information processing system, an information processing method, and an information processing program.

### BACKGROUND ART

Hitherto, technology for tracking the movements of the hands of a user has been known for the purpose of use in virtual reality (VR) and the like (for example, see PTL 1).

In the invention described in PTL 1, the positions of the fingertips of a user are tracked by a glove including sensors at positions corresponding to the fingertips of the user. The information indicating the positions tracked by the glove is converted into various control signals and used for various purposes, such as the generation and display of an image reproducing the hands of the user in a virtual space, for example.

### CITATION LIST

### Patent Literature

[PTL 1] U.S. Patent Application Publication No. 2016/024369

### SUMMARY

### Technical Problems

In generating the reproduced image in the virtual space described above, in a case where the visual differences between the actual hands of the user and the reproduced image are large, the user has a feeling of strangeness in some cases.

Therefore, it has been demanded to reduce such a feeling of strangeness and enhance reality and immersion, thereby providing a better experience to the user.

### Solution to Problems

An operating apparatus according to a first aspect of the present invention is an operating apparatus configured to receive an operation performed by a user and includes a detection unit configured to detect the operation, an acquisition unit configured to acquire a first image in which a hand of the user is captured, a feature information generation unit configured to generate feature information regarding the hand on the basis of the first image, and a feature information output unit configured to output a detection result obtained by the detection unit and the feature information.

An information processing apparatus according to a second aspect of the present invention includes an acquisition unit configured to acquire a detection result obtained by an operating apparatus and a first image in which a hand of a user is captured, the operating apparatus including a detection unit configured to detect an operation performed by the user, a feature information generation unit configured to generate feature information regarding the hand on the basis of the first image, an image generation unit configured to generate a second image reproducing a shape of the hand, on the basis of the detection result obtained by the detection unit and the feature information, and a display unit configured to display the second image.

An information processing apparatus according to a third aspect of the present invention includes an acquisition unit configured to acquire a detection result obtained by an operating apparatus and a first image in which a hand of a user is captured, the operating apparatus including a detection unit configured to detect an operation performed by the user, a feature information generation unit configured to generate feature information regarding the hand on the basis of the first image, an operation information generation unit configured to generate operation information for operating an operation target, on the basis of the detection result obtained by the detection unit, an operation information adjustment unit configured to adjust the operation information on the basis of the feature information, and an operation information output unit configured to output the operation information adjusted to the operation target.

An information processing method according to a fourth aspect of the present invention is an information processing method that is implemented by an operating apparatus that includes a detection unit and receives an operation performed by a user, and includes an acquisition procedure of acquiring a first image in which a hand of the user is captured, a feature information generation procedure of generating feature information regarding the hand on the basis of the first image, and a feature information output procedure of outputting a detection result obtained by the detection unit and the feature information.

An information processing program according to a fifth aspect of the present invention is an information processing program that is executed by an information terminal connected to an operating apparatus that includes a detection unit and receives an operation performed by a user, for causing the information terminal to execute an acquisition step of acquiring a first image in which a hand of the user is captured, a feature information generation step of generating feature information regarding the hand on the basis of the first image, and a feature information output step of outputting a detection result obtained by the detection unit and the feature information.

### BRIEF DESCRIPTION OF DRAWINGS

FIG. 1 is a schematic diagram illustrating a schematic configuration of an information processing system according to a first embodiment.

FIG. 2 is a perspective view schematically illustrating an operating apparatus according to the first embodiment.

FIG. 3A is a diagram illustrating an example of a reference image.

FIG. 3B is a diagram illustrating feature information.

FIG. 4A is a diagram illustrating an example of a model image.

FIG. 4B is a diagram illustrating the adjustment of a three-dimensional (3D) model based on the feature information.

FIG. 5 is a flowchart illustrating an example of a processing method according to the first embodiment.

FIG. 6 is a schematic diagram illustrating a schematic configuration of an information processing system according to a second embodiment.

FIG. 7 is a flowchart illustrating an example of a processing method according to the second embodiment.

### DESCRIPTION OF EMBODIMENTS

### First Embodiment

Now, a first embodiment of the present invention is described on the basis of the drawings.

### [Schematic Configuration of Information Processing System]

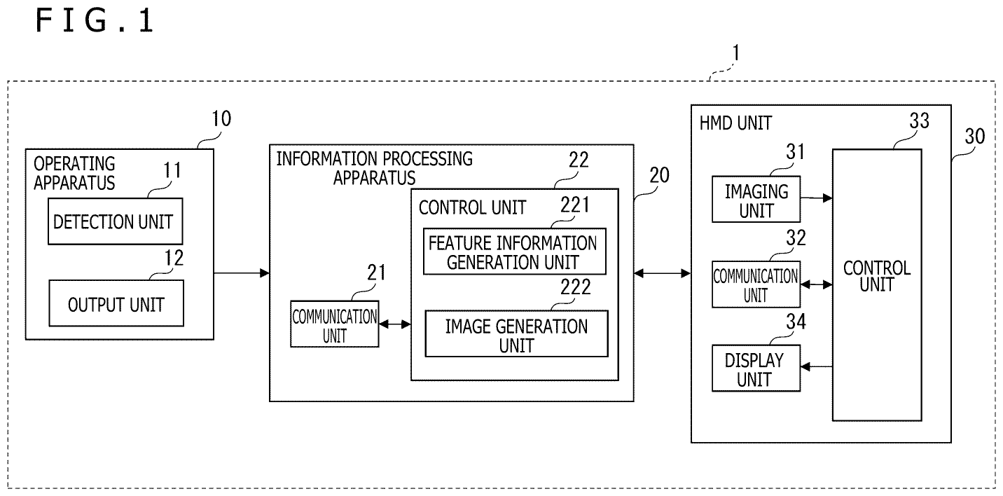

FIG. 1 is a schematic diagram illustrating a schematic configuration of an information processing system according to the first embodiment.

An information processing system 1 according to the first embodiment includes, as illustrated in FIG. 1, an operating apparatus 10, an information processing apparatus 20, and a head-mounted display (HMD) unit 30. The information processing system 1 generates a model image (second image) reproducing the hands of a user in a virtual space, by the information processing apparatus 20 in response to operations on the operating apparatus 10, and displays the model image (second image) on the HMD unit 30.

### [Configuration of Operating Apparatus]

The operating apparatus 10 includes a detection unit 11 and an output unit 12 and receives operations performed by the user. The detection unit 11 detects the position of the hand (hand and fingers) of the user. The output unit 12 outputs detection results obtained by the detection unit 11 to the outside of the operating apparatus 10 via wireless or wired communication.

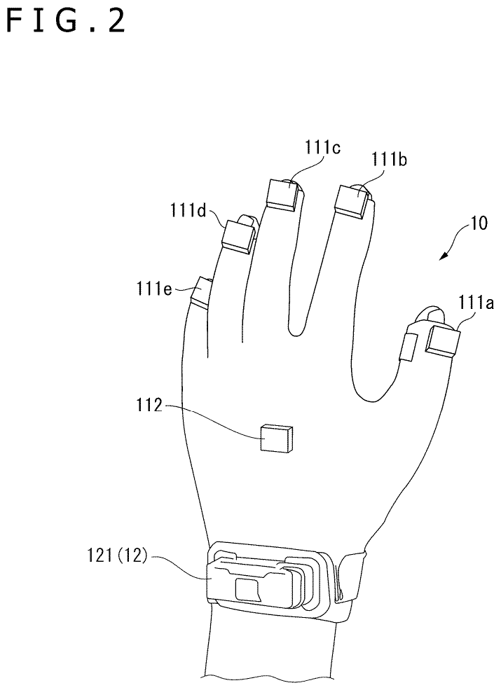

FIG. 2 is a perspective view schematically illustrating the operating apparatus 10.

As illustrated in FIG. 2, the operating apparatus 10 is attached to the hand of the user by a glove-shaped attachment member. The attachment member preferably contains a material that can adhere closely to the hand of the user and is stretchable.

The operating apparatus 10 includes, as the detection unit 11, as illustrated in FIG. 2, for example, a plurality of sensors 111a, 111b, 111c, 111d, and 111e provided in correspondence with the respective fingers and a sensor 112 provided in correspondence with a position other than the fingers on the hand of the user.

The plurality of sensors 111a, 111b, 111c, 111d, and 111e are provided at positions corresponding to the fingertips of the respective fingers and on the nail side of the respective fingers. To be specific, for example, the sensor 111a is provided in correspondence with the first finger (thumb) as illustrated in FIG. 2 and detects the position of the sensor 111a as the position of the fingertip of the thumb. Similarly, the sensors 111b, 111c, 111d, and 111e are provided in correspondence with the second finger (index finger), the third finger (middle finger), the fourth finger (ring finger), and the fifth finger (little finger), respectively, and detect the positions of the respective sensors as the positions of the fingertips of the respective fingers.

The sensor 112 is provided at a position corresponding to the back of the hand and detects the position of the sensor 112 as the position of the back of the hand.

In the present embodiment, as each of the sensors 11a, 111b, 111c, 111d, and 111e, and the sensor 112, any known sensor may be used. Further, the placement positions of the sensors 111a, 111b, 111c, 111d, and 111e, and the sensor 112 are not limited to the example of FIG. 2. For example, the sensors 111a, 111b, 111c, 111d, and 111e may be provided at positions on the palm side of the respective fingers, at the distal ends of the respective fingers, or in such a manner as to cover a part or all of the respective fingers.

In the present embodiment, as illustrated in FIG. 2, the output unit 12 is provided within a housing 121 provided at a position corresponding to the wrist of the user. Note that, in a case where the operating apparatus 10 includes a control unit configured to control each unit, it is preferable that the control unit be also provided within the housing 121. Further, the housing 121 may be provided at the same position as the sensor 112, which is provided at the position corresponding to the back of the hand described above, integrally or independently, or at other positions.

### [Configuration of Information Processing Apparatus]

The information processing apparatus 20 includes, as illustrated in FIG. 1, a communication unit 21 and a control unit 22.

The communication unit 21 receives detection results obtained by the detection unit 11 and output from the output unit 12 of the operating apparatus 10, and is connected to a communication unit 32 of the HMD unit 30 via wireless or wired communication.

The control unit 22 includes the respective functions of a feature information generation unit 221 and an image generation unit 222, which are achieved by a processor operating in accordance with a program stored in a memory or received via a communication interface. The functions of the respective unit are described later.

### [Configuration of HMD Unit]

The HMD unit 30 can be used by being attached to the head of the user with an attachment unit, which is not illustrated. Further, the HMD unit 30 has the function of a display apparatus and the function of an imaging apparatus configured to perform imaging from the user's first-person perspective, which is what is generally called inside-out imaging. The HMD unit 30 may be configured to be attached to the head of the user with an attachment unit such as a band, or may be of any configuration such as a helmet type or a glasses type.

Further, in attaching the HMD unit 30, for example, it is preferable to display a tutorial or the like on the display apparatus of the HMD unit 30, thereby guiding the user to properly attach the HMD unit 30.

The HMD unit 30 includes, as illustrated in FIG. 1, the respective units of an imaging unit 31, the communication unit 32, a control unit 33, and a display unit 34.

The imaging unit 31 includes an imaging element, which is not illustrated, and generates images by performing imaging from the user's first-person perspective. The imaging element may be an image sensor configured to generate images including color information, or a depth sensor configured to generate images including depth information. Further, the imaging unit 31 may be provided with a plurality of imaging elements. For example, the imaging unit 31 may include both an image sensor and a depth sensor, and the image sensor and the depth sensor may generate images including color information and images including depth information, respectively. Further, for example, the imaging unit 31 may include a plurality of image sensors to generate images including color information, and to generate depth information from the plurality of images.

The imaging unit 31 captures a reference image (first image) in which the hands of the user are captured. The reference image is information that is used for generating a model image reproducing the hands of the user in a virtual space.

The communication unit 32 is connected to the communication unit 21 of the information processing apparatus 20 via wireless or wired communication.

The control unit 33 controls each unit within the HMD unit 30.

The display unit 34 includes a display element such as a liquid crystal display (LCD) or an organic electroluminescent (EL) display and an optical apparatus such as a lens, for example. The display unit 34 is capable of presenting the display images to the user by displaying display images. Note that the display element of the display unit 34 may be a transmissive display element or a non-transmissive display element.

Further, a terminal apparatus such as a smartphone that can be attached to and detached from the housing of the HMD unit 30 may be used as the display apparatus. Moreover, a wearable device such as augmented reality (AR) glasses or mixed reality (MR) glasses may be used as the HMD unit 30.

Next, the functions of the respective unit in the control unit 22 of the information processing apparatus 20 are described.

The feature information generation unit 221 generates feature information regarding the hands on the basis of a reference image. The feature information is, like the reference image described above, information that is used for generating a model image, and includes at least one of the following two types.

### (1) Position Information Regarding Feature Points on Hands

For example, the feature information generation unit 221 uses machine learning techniques to calculate position information regarding feature points such as joint information regarding the hands of the user from a reference image. Examples of the feature points include the endpoints of each finger, the joints of each finger, and wrist joints. For example, the trained model that is used for machine learning can be constructed in advance by executing supervised learning using images of the hands of a person with a plurality of feature points as input data, and coordinate information indicating the positions of the feature points on the hands of the person as ground truth data.

Note that, regarding the specific machine learning technique, since various known technologies can be used, the detailed description thereof is omitted. Further, the feature information generation unit 221 may include a relation learning unit and update, each time a reference image is generated, the trained model through learning of the relation between an image based on the input reference image and coordinate information indicating the positions of the feature points on the hands of the person.

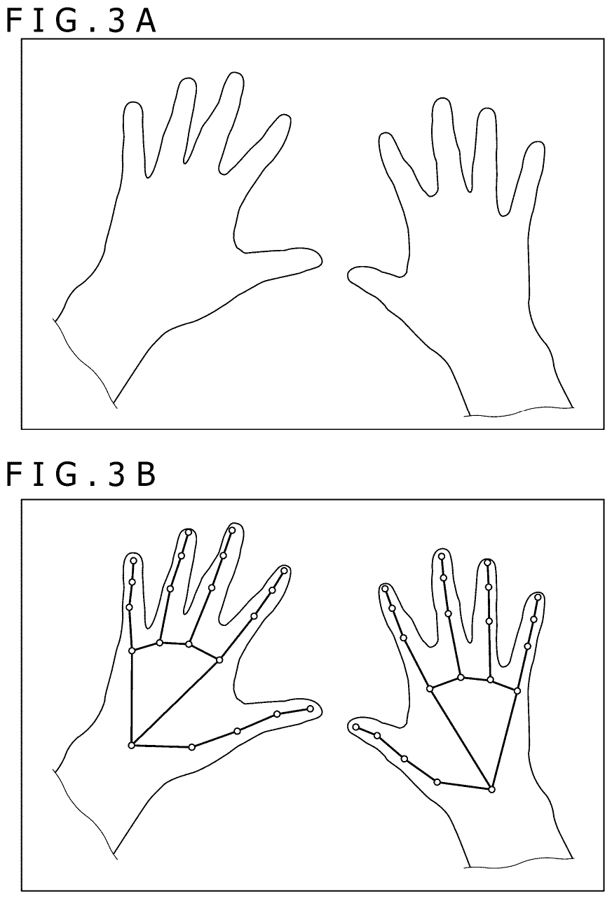

FIG. 3B exemplifies feature points based on a reference image. In the example of FIG. 3B, the endpoints of each finger, the joints of each finger, and the wrist joints are detected as feature points, and position information regarding each feature point is calculated as feature information. The position information regarding the feature points on the hands is generated as feature information, and the relative positional relations of these feature points are determined, thereby enabling accurate realization of the lengths of the actual hands of the user, the ratios of each part of the hands, and the like.

Further, for example, the feature information generation unit 221 may use such techniques as skin color detection on a reference image including color information to extract the silhouettes of the hands of the user, and may generate position information regarding the feature points on the hands on the basis of the extracted silhouettes.

Further, for example, the feature information generation unit 221 may estimate, for a reference image including depth information, the thicknesses around the joints of the fingers and the like on the basis of the depth information and thereby generate position information regarding the feature points on the hands.

### (2) Texture Information Regarding Surfaces of Hands

For example, the feature information generation unit 221 uses such techniques as skin color detection to calculate texture information indicating the surface conditions of the hands of the user, from a reference image. The texture information includes, for example, the user's skin color tone and texture, as well as surface irregularities of the hands such as scratches, moles, and wrinkles.

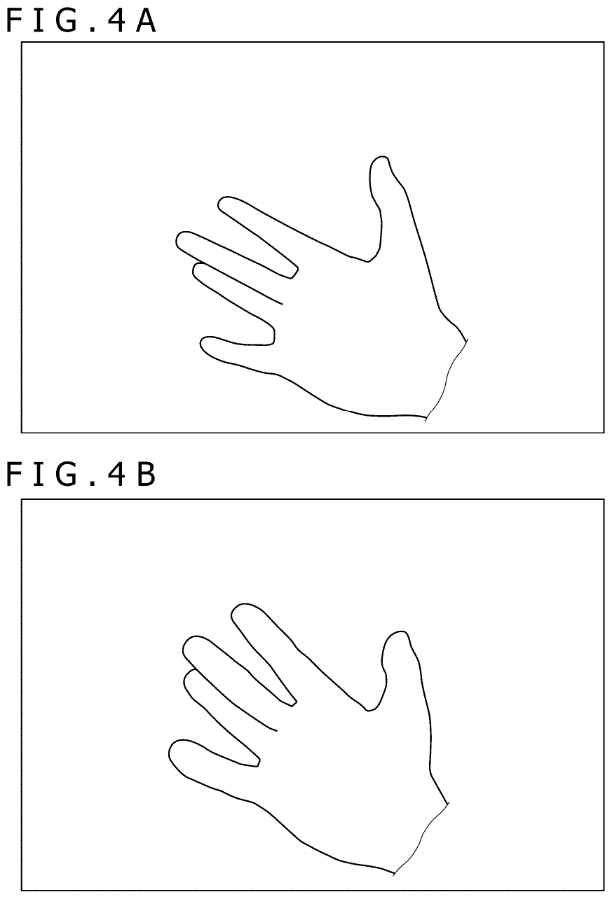

The image generation unit 222 generates a model image (second image) reproducing the hands of the user in a virtual space, on the basis of a detection result received from the operating apparatus 10 via the communication unit 21. FIG. 4A exemplifies a model image.

The image generation unit 222 controls a 3D model of the hand on the basis of a detection result received from the operating apparatus 10 described above, adjusts the 3D model of the hand on the basis of feature information generated by the feature information generation unit 221, and generates a model image on the basis of the adjusted 3D model.

More specifically, for example, the image generation unit 222 specifies, by utilizing known Inverse Kinematics (hereinafter referred to as “IK”) technology, a start point (IK root), an end point (IK end), and a target point (IK goal) for the joints to perform posture correction such as flexion and extension movements, and thereby controls the 3D model of the skeleton (bone) of the hand. In IK technology, when the distal end of a joint structure is moved, the rotation of the intermediate joint is traced in the reverse direction (parent direction), correction calculations are thereby performed. Further, the image generation unit 222 performs skinning processing for setting the influence range of the skeleton on the 3D model, and thereby generates a model image.

In a case where IK technology is used to move the intermediate joints of the hand in a model image, it is desirable that the skeleton of the 3D model from which the model image is generated match the skeleton of the hand based on a detection result received from the operating apparatus 10. For example, in a case where the hand of the 3D model is larger than the hand of the user operating the operating apparatus 10, the sensors (sensors 111a, 111b, 111c, 111d, and 111e) are embedded in the fingertips of the 3D model. Further, in a case where the hand of the 3D model is smaller than the hand of the user operating the operating apparatus 10, the sensors (sensors 111a, 111b, 111c, 111d, and 111e) are present at positions away from the fingertips. In such cases, there are problems in that, since the skeleton of the 3D model from which the model image is generated does not match the skeleton of the hand based on the detection result received from the operating apparatus 10, the flexion of the intermediate joints is not correctly reproduced in the model image generated on the basis of the 3D model, leading to unnatural movement and causing a feeling of strangeness to the user.

Therefore, to eliminate or reduce the problems described above, the image generation unit 222 adjusts the 3D model as needed on the basis of feature information generated by the feature information generation unit 221 and then generates a model image. The generation of a model image is performed on the basis of the type of feature information.

### (1) Position Information Regarding Feature Points on Hands

In a case where the feature information is the position information regarding the feature points on the hand, the image generation unit 222 adjusts the length of the hand and the ratios of each part of the hand in the 3D model on the basis of the feature information. More specifically, the image generation unit 222 enlarges or reduces the hand in the 3D model, extends or contracts the length of the hand in the 3D model on the basis of the feature information, or changes the ratios of each part of the hand in the 3D model on the basis of the feature information, and thereby adjusts the 3D model.

Then, the image generation unit 222 performs skinning processing on the adjusted 3D model, and thereby generates a model image.

### (2) Texture Information Regarding Surfaces of Hands

In a case where the feature information is the texture information regarding the surface of the hand, the image generation unit 222 generates a model image by using an image of the hand part in the reference image as a texture for the hand part in the model image, or by reflecting, in the hand part in the model image, the user's skin color tone and texture as well as surface irregularities of the hand such as scratches, moles, and wrinkles on the basis of the feature information. Note that, in a case where images of both the palm side and back side of the hand of the user are captured as reference images, images of both sides are adjusted also in the model image.

FIG. 4B exemplifies a model image generated on the basis of feature information. In the example of FIG. 4B, as a result of adjustment of the balance of the lengths of each finger, the thicknesses of each finger, and the like in the 3D model, a model image closer to the actual hand of the user is generated.

Note that, in a case where the feature information includes both (1) and (2) described above, the image generation unit 222 may perform the image generation processing processes described in (1) and (2) in combination or only one of the image generation processing processes. Further, the contents of the image generation processing may be settable by the user.

### [Flow of Information Processing]

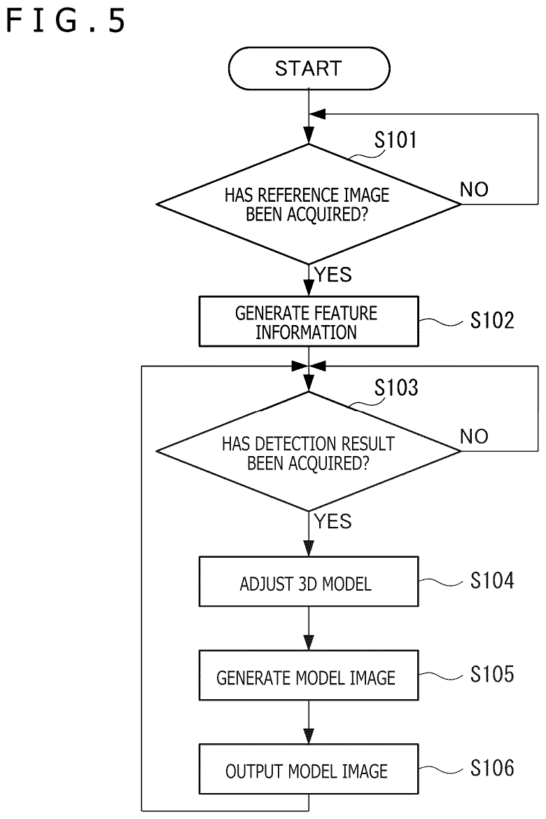

FIG. 5 is a flowchart illustrating the processing that is executed by the control unit 22.

The control unit 22 determines whether a reference image has been acquired by the imaging unit 31 or not (Step S101). When the control unit 22 determines that a reference image has been acquired (YES in Step S101), the feature information generation unit 221 generates feature information on the basis of the reference image (Step S102).

Then, the control unit 22 determines whether a detection result obtained by the operating apparatus 10 has been acquired via the communication unit 21 or not (Step S103). When the control unit 22 determines that a detection result has been acquired (YES in Step S103), the image generation unit 232 adjusts the 3D model image on the basis of the feature information generated in Step S102 (Step S104), to generate a model image (Step S105).

Moreover, when the communication unit 21 outputs the generated model image to the HMD unit 30 (Step S106), the processing returns to Step S103.

That is, in a case where the feature information has been generated once by the processing in Step S101 and Step S102, thereafter, the processing from Step S103 to Step S106 is repeatedly executed each time a detection result obtained by the operating apparatus 10 is acquired. Thus, since a model image is output to the HMD unit 30 each time a detection result obtained by the operating apparatus 10 is acquired, the model image displayed on the display unit 24 is sequentially updated, and at that time, a model image based on the reference image is always generated.

### Effects of First Embodiment

The information processing system 1 according to the first embodiment described above has the following effects.

The information processing apparatus 20 includes the acquisition unit (communication unit 21) configured to acquire a detection result obtained by the operating apparatus 10 including the detection unit 11 configured to detect an operation performed by the user and a reference image that is a first image in which the hand of the user is captured, the feature information generation unit 221 configured to generate feature information regarding the hand on the basis of the reference image, and the image generation unit 232 configured to generate a model image that is a second image reproducing the shape of the hand, on the basis of the detection result obtained by the detection unit 11 and the feature information.

With such a configuration, the shape of the actual hand of the user is accurately scaled and handled, thereby enabling a reduction in the difference between the actual hand of the user and the hand of the user reproduced in the model image and a reduction in the feeling of strangeness given to the user. As a result, it is possible to enhance reality and immersion, thereby providing a better experience to the user.

The image generation unit 222 controls the 3D model of the hand on the basis of the detection result and adjusts the 3D model of the hand on the basis of the feature information, to generate the model image on the basis of the 3D model adjusted.

With such a configuration, the skeleton of the 3D model from which the model image is generated matches the skeleton of the hand based on the detection result received from the operating apparatus 10, thereby enabling correct reproduction of the movement of the hand in the model image.

The feature information generated by the feature information generation unit 221 includes position information regarding the feature point on the hand.

With such a configuration, the model image is adjusted on the basis of the position information regarding the feature point on the hand, thereby enabling accurate reproduction of the shape of the actual hand of the user. Thus, it is possible to eliminate or reduce the defects occurring in the model image and accurately reproduce the actual hand of the user and the movement thereof in the model image.

The feature information generated by the feature information generation unit 221 includes texture information regarding the surface of the hand.

With such a configuration, the model image is adjusted on the basis of the texture information regarding the surface of the hand, thereby enabling favorable reproduction of the atmosphere and appearance of the actual hand of the user. Thus, it can be expected to enhance reality and immersion.

In the HMD unit 30, which is an information processing apparatus, the reference image captured by the imaging unit 31 is an image including at least one of color information and depth information.

With such a configuration, the feature information necessary for adjusting the model image can readily be generated from the easily acquirable reference image.

### Second Embodiment

Now, a second embodiment of the present invention is described with reference to the drawings. In the second embodiment, only parts that differ from those of the first embodiment are described, and the description of the parts that are similar to those of the first embodiment is omitted. Further, in the second embodiment, components that have substantially the same functional configuration as those of the first embodiment are denoted by the same reference signs.

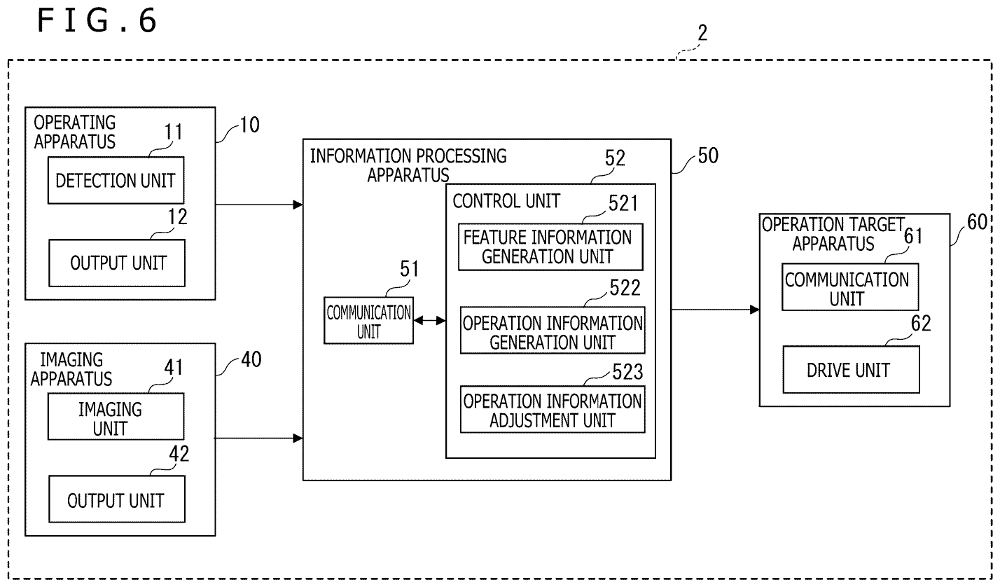

FIG. 6 is a schematic diagram illustrating the entirety of an information processing system according to the second embodiment of the present invention.

An information processing system 2 according to the second embodiment includes, as illustrated in FIG. 6, in place of the information processing apparatus 20 and the HMD unit 30 of the information processing system 1 of the first embodiment, an imaging apparatus 40, an information processing apparatus 50, and an operation target apparatus 60. The information processing system 2 generates operation information in the information processing apparatus 50 in response to operations on the operating apparatus 10 and controls the operation target apparatus 60 on the basis of the operation information.

### [Configuration of Imaging Apparatus 40]

The imaging apparatus 40 includes, as illustrated in FIG. 6, an imaging unit 41 and an output unit 42. The imaging unit 41 includes an imaging element, which is not illustrated, and generates images by performing imaging from the user's third-person perspective, which is what is generally called outside-in imaging. The details of the imaging element and the number of imaging elements are similar to those of the imaging unit 31 of the HMD unit 30 in the information processing system 1 of the first embodiment, and hence, the description thereof is omitted.

Further, the imaging unit 41 captures a reference image (first image) in which the hands of the user are captured, as with the imaging unit 31 of the HMD unit 30 in the information processing system 1 of the first embodiment.

The output unit 42 outputs reference images captured by the imaging unit 41 to the outside of the imaging apparatus 40 via wireless or wired communication.

### [Configuration of Information Processing Apparatus 50]

The information processing apparatus 50 includes, as illustrated in FIG. 6, a communication unit 51 and a control unit 52.

The communication unit 51 receives detection results obtained by the detection unit 11 and output from the output unit 12 of the operating apparatus 10 and reference images output from the output unit 42 of the imaging apparatus 40. Moreover, the communication unit 51 outputs operation information generated by the control unit 52 to the outside of the information processing apparatus 50 via wireless or wired communication. The details of the operation information are described later.

The control unit 52 includes the respective functions of a feature information generation unit 521, an operation information generation unit 522, and an operation information adjustment unit 523, which are achieved by a processor operating in accordance with a program stored in a memory or received via a communication interface. Now, the functions of the respective unit are further described.

The feature information generation unit 521 generates feature information regarding the hands on the basis of a reference image. The feature information includes position information regarding the feature points on the hands.

The feature information generation unit 521 calculates position information regarding the feature points on the hands of the user from the reference image, as with the feature information generation unit 221 in the information processing apparatus 20 of the first embodiment.

The operation information generation unit 522 generates operation information for operating the operation target apparatus 60, on the basis of detection results received from the operating apparatus 10 via the communication unit 51. The operation information may be the detection results per se or control information indicating the drive parts and drive amounts of the operation target apparatus 60 calculated on the basis of the detection results.

Here, in a case where the difference between the actual hand of the user and the corresponding part of the operation target apparatus 60 is large, malfunctions occur in the operation of the operation target apparatus 60 in some cases. For example, in a case where the size of the corresponding part of the operation target apparatus 60 is significantly different compared to the size of the actual hand of the user, the operation at the corresponding part of the operation target apparatus 60 is not reproduced correctly in some cases.

That is, in a case where there is no difference, or the difference is sufficiently small, between the actual hand of the user and the corresponding part of the operation target apparatus 60, the movement of the actual hand of the user is reproduced correctly by the operation target apparatus 60.

To eliminate or reduce the problems described above, the operation information adjustment unit 523 adjusts operation information generated by the operation information generation unit 522, on the basis of feature information generated by the feature information generation unit 521. The specific method of adjustment is described later.

### [Configuration of Operation Target Apparatus 60]

The operation target apparatus 60 is an apparatus that is operated in response to operations on the operating apparatus 10. Examples of the operation target apparatus 60 include robot hands and manipulators.

The operation target apparatus 60 includes, as illustrated in FIG. 6, a communication unit 61 and a drive unit 62.

The communication unit 61 receives operation information output from the communication unit 51 of the information processing apparatus 50.

The drive unit 62 includes, depending on the robot hand shape and the manipulator shape, a plurality of motors and actuators such as servomotors and drives at least one of them. At this time, the drive unit 62 drives at least one of the motors and actuators on the basis of operation information (for example, control signals for operating the servomotors) received via the communication unit 61.

Note that, regarding the drive unit 62, the installation positions of the motors and actuators may be fixed or movable. For example, in a case where the operation target apparatus 60 is a robot hand, the motors and actuators of the drive unit 62 installed in the joint parts and the like of the robot hand may be fixed or movable. In either case, the information indicating the installation positions of the motors and actuators in the drive unit 62 of the operation target apparatus 60 is stored in the control unit 52 in advance, or can be acquired from the operation target apparatus 60 via the communication unit 51. The same holds true for a case where the operation target apparatus 60 is a manipulator.

### [Adjustment of Operation Information]

In a case where the installation positions of the motors and actuators in the drive unit 62 of the operation target apparatus 60 are fixed, the operation information adjustment unit 523 adjusts operation information on the basis of feature information. More specifically, the operation information adjustment unit 523 first determines the correlation between feature points in feature information and the installation position of the drive unit 62. Then, the operation information adjustment unit 523 adjusts the operation information on the basis of the correlation. That is, the operation information is aligned with the installation position of the drive unit 62 in the operation target apparatus 60, and the differences between the actual hand of the user and the installation positions of the motors and actuators in the drive unit 62 of the operation target apparatus 60 are thereby reduced.

On the other hand, in a case where the installation positions of the motors and actuators in the drive unit 62 of the operation target apparatus 60 are movable, as in the model image adjustment described in the first embodiment, the operation information adjustment unit 523 adjusts operation information by adding, to the operation information, adjustment information for enlarging or reducing the installation positions of the motors and actuators on the basis of feature information, adjustment information for extending or contracting the lengths between the installation positions of the motors and actuators on the basis of feature information, adjustment information for changing the installation positions of the motors and actuators on the basis of feature information, and the like. That is, the installation positions of the motors and actuators in the drive unit 62 of the operation target apparatus 60 are adjusted to match the shape of the actual hand of the user, thereby reducing the differences between the actual hand of the user and the installation positions of the motors and actuators in the drive unit 62 of the operation target apparatus 60.

As described so far, the information processing apparatus 50 receives a detection result from the operating apparatus 10 and a reference image from the imaging apparatus 40. Further, the information processing apparatus 50 calculates feature information on the basis of the reference image. Moreover, the information processing apparatus 50 generates operation information on the basis of the detection result and adjusts the operation information on the basis of the feature information.

### [Flow of Information Processing]

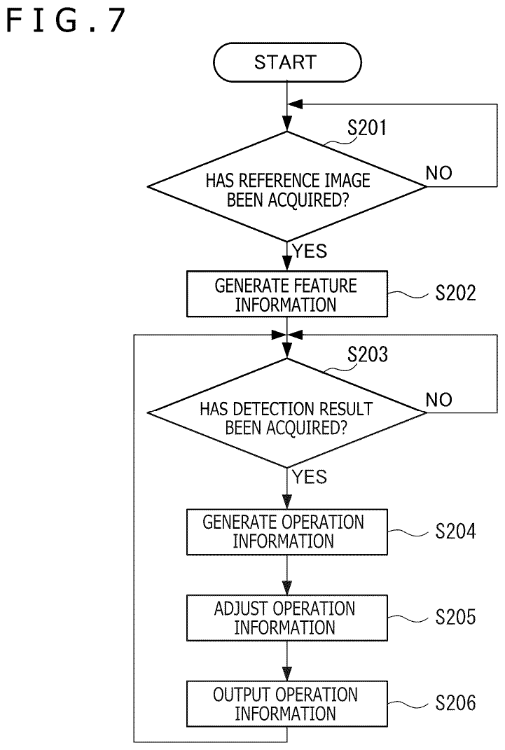

FIG. 7 is a flowchart illustrating the processing that is executed by the control unit 52 of the information processing apparatus 50.

The control unit 52 determines whether a reference image has been acquired via the communication unit 51 or not (Step S201). When the control unit 52 determines that a reference image has been acquired (YES in Step S201), the feature information generation unit 521 generates feature information on the basis of the reference image (Step S202).

Then, the control unit 52 determines whether a detection result obtained by the operating apparatus 10 has been acquired via the communication unit 51 or not (Step S203). When the control unit 52 determines that a detection result has been acquired (YES in Step S203), the operation information generation unit 522 generates operation information (Step S204), and the operation information adjustment unit 523 adjusts the operation information on the basis of the feature information generated in Step S202 (Step S205).

Moreover, when the communication unit 51 outputs the adjusted operation information (Step S206), the processing returns to Step S203.

That is, in a case where the feature information has been generated once by the processing in Step S201 and Step S202, thereafter, the processing from Step S203 to Step S206 is repeatedly executed each time a detection result obtained by the operating apparatus 10 is acquired. Thus, operation information is output each time a detection result obtained by the operating apparatus 10 is acquired, and at that time, the operation information is always adjusted on the basis of the reference image.

### Effects of Second Embodiment

The information processing system 2 according to the second embodiment described above has the following effects.

The information processing apparatus 50 includes the acquisition unit (communication unit 51) configured to acquire a detection result obtained by the operating apparatus 10 including the detection unit 11 configured to detect an operation performed by the user and a reference image that is a first image in which the hand of the user is captured, the feature information generation unit 521 configured to generate feature information regarding the hand on the basis of the reference image, the operation information generation unit 522 configured to generate operation information for operating the operation target apparatus 60, which is an operation target, on the basis of the detection result obtained by the detection unit 11, and the operation information adjustment unit 523 configured to adjust the operation information on the basis of the feature information. The operation information adjusted is output to the operation target apparatus 60 via the communication unit 51.

With such a configuration, the operation information is adjusted on the basis of the position information regarding the feature point on the hand, thereby enabling accurate reproduction of the movement of the actual hand of the user by the operation target. Thus, malfunctions occurring in the operation of the operation target can be eliminated or reduced. In particular, individual differences in hand shape among users can be absorbed.

### Modifications of Embodiments

The present invention is not limited to each embodiment described above, and modifications and improvements within the scope that can achieve the object of the present invention are included in the present invention.

In the above-mentioned first embodiment, the operating apparatus 10 is attached to the hand of the user by the glove-shaped attachment member, and the position of the hand (hand and fingers) of the user is detected by the detection unit 11. However, the present invention is not limited to this, and the present invention can similarly be applied to the operating apparatus 10 with a stick shape or the like that the user grips with his/her hand.

In the above-mentioned first embodiment, the description has been given by taking the information processing apparatus 20 and the HMD unit 30 as examples of information processing apparatuses. However, the present invention is not limited to this, and the present invention can similarly be applied to other information processing apparatuses including an imaging apparatus internally or externally, as in the second embodiment.

Apart of the processing performed by the HMD unit 30, which is an information processing apparatus, in the above-mentioned first embodiment may be performed by the operating apparatus 10. For example, a part or all of the respective functions of the feature information generation unit 221 and the image generation unit 222 in the HMD unit 30 of the first embodiment may be performed by the operating apparatus 10. Further, the control unit 22 of the information processing apparatus 20 may be provided in the HMD unit 30.

A part of the processing performed by the information processing apparatus 50 in the above-mentioned second embodiment may be performed by the operating apparatus 10 or the operation target apparatus 60. For example, a part or all of the respective functions of the feature information generation unit 521, the operation information generation unit 522, and the operation information adjustment unit 523 in the information processing apparatus 50 of the second embodiment may be performed by the operating apparatus 10. Further, for example, a part or all of the respective functions of the feature information generation unit 521, the operation information generation unit 522, and the operation information adjustment unit 523 in the information processing apparatus 50 of the second embodiment may be performed by the operation target apparatus 60.

In each embodiment described above, the operating apparatus 10 is attached to the hand of the user by the glove-shaped attachment member. However, the present invention is not limited to this, and the attachment member may have a band shape. Further, the operating apparatus 10 may be what is generally called an exoskeleton controller.

### SUMMARY OF PRESENT INVENTION

The following is a summary of the present invention.
[1] An operating apparatus configured to receive an operation performed by a user, the operating apparatus including a detection unit configured to detect the operation, an acquisition unit configured to acquire a first image in which a hand of the user is captured, a feature information generation unit configured to generate feature information regarding the hand on the basis of the first image, and a feature information output unit configured to output a detection result obtained by the detection unit and the feature information.
[2] The operating apparatus according to [1], in which the feature information includes position information regarding a feature point on the hand.
[3] The operating apparatus according to [1] or [2], in which the feature information includes texture information regarding a surface of the hand.
[4] The operating apparatus according to any one of [1] to [3], in which the detection unit detects a position of the hand.
[5] The operating apparatus according to any one of [1] to [4], in which the first image is an image including at least one of color information and depth information.
[6] An information processing apparatus including an acquisition unit configured to acquire a detection result obtained by an operating apparatus and a first image in which a hand of a user is captured, the operating apparatus including a detection unit configured to detect an operation performed by the user, a feature information generation unit configured to generate feature information regarding the hand on the basis of the first image, an image generation unit configured to generate a second image reproducing a shape of the hand, on the basis of the detection result obtained by the detection unit and the feature information, and a display unit configured to display the second image.
[7] The information processing apparatus according to [6], in which the image generation unit controls a 3D model of the hand on the basis of the detection result and adjusts the 3D model of the hand on the basis of the feature information, and thereby generates the second image on the basis of the 3D model adjusted.
[8] An information processing apparatus including an acquisition unit configured to acquire a detection result obtained by an operating apparatus and a first image in which a hand of a user is captured, the operating apparatus including a detection unit configured to detect an operation performed by the user, a feature information generation unit configured to generate feature information regarding the hand on the basis of the first image, an operation information generation unit configured to generate operation information for operating an operation target, on the basis of the detection result obtained by the detection unit, an operation information adjustment unit configured to adjust the operation information on the basis of the feature information, and an operation information output unit configured to output the operation information adjusted to the operation target.
[9] An information processing system including an operating apparatus including a detection unit configured to detect an operation performed by a user, and the information processing apparatus according to [6] or [8].
[10] The information processing system according to [9], in which the information processing apparatus further includes an imaging unit that includes an imaging element and that is configured to capture the first image.
[11] The information processing system according to [10], in which the information processing apparatus further includes an attachment unit configured to allow at least the imaging element to be attached to a body of the user.
[12] An information processing system including an operating apparatus including a detection unit configured to detect an operation performed by a user, the information processing apparatus according to [8], and an operation target configured to operate on the basis of operation information based on the detection result.
[13] An information processing method that is implemented by an operating apparatus that includes a detection unit and receives an operation performed by a user, the information processing method including an acquisition procedure of acquiring a first image in which a hand of the user is captured, a feature information generation procedure of generating feature information regarding the hand on the basis of the first image, and a feature information output procedure of outputting a detection result obtained by the detection unit and the feature information.
[14] An information processing program that is executed by an information terminal connected to an operating apparatus that includes a detection unit and receives an operation performed by a user, for causing the information terminal to execute an acquisition step of acquiring a first image in which a hand of the user is captured, a feature information generation step of generating feature information regarding the hand on the basis of the first image, and a feature information output step of outputting a detection result obtained by the detection unit and the feature information.

### REFERENCE SIGNS LIST

1, 2: Information processing system
10: Operating apparatus
11: Detection unit
12, 42: Output unit
31, 41: Imaging unit
21, 32, 51, 61: Communication unit
22, 33, 52: Control unit
30: HMD unit
34: Display unit
40, 50: Information processing apparatus
60: Operation target apparatus
62: Drive unit
111a to 111e, 112: Sensor
221, 521: Feature information generation unit
222: Image generation unit
522: Operation information generation unit
523: Operation information adjustment unit

1. An operating apparatus configured to receive an operation performed by a user, the operating apparatus comprising:
a detection unit configured to detect the operation;
an acquisition unit configured to acquire a first image in which a hand of the user is captured;
a feature information generation unit configured to generate feature information regarding the hand on a basis of the first image; and
a feature information output unit configured to output a detection result obtained by the detection unit and the feature information.

2. The operating apparatus according to claim 1, wherein the feature information includes position information regarding a feature point on the hand.

3. The operating apparatus according to claim 1, wherein the feature information includes texture information regarding a surface of the hand.

4. The operating apparatus according to claim 1, wherein the detection unit detects a position of the hand.

5. The operating apparatus according to claim 1, wherein the first image is an image including at least one of color information and depth information.

6. An information processing apparatus comprising:
an acquisition unit configured to acquire a detection result obtained by an operating apparatus and a first image in which a hand of a user is captured, the operating apparatus including a detection unit configured to detect an operation performed by the user;
a feature information generation unit configured to generate feature information regarding the hand on a basis of the first image;
an image generation unit configured to generate a second image reproducing a shape of the hand, on a basis of the detection result obtained by the detection unit and the feature information; and
a display unit configured to display the second image.

7. The information processing apparatus according to claim 6, wherein the image generation unit controls a three-dimensional model of the hand on the basis of the detection result and adjusts the three-dimensional model of the hand on the basis of the feature information, and thereby generates the second image on a basis of the three-dimensional model adjusted.

8. An information processing apparatus comprising:
an acquisition unit configured to acquire a detection result obtained by an operating apparatus and a first image in which a hand of a user is captured, the operating apparatus including a detection unit configured to detect an operation performed by the user;
a feature information generation unit configured to generate feature information regarding the hand on a basis of the first image;
an operation information generation unit configured to generate operation information for operating an operation target, on a basis of the detection result obtained by the detection unit;
an operation information adjustment unit configured to adjust the operation information on a basis of the feature information; and
an operation information output unit configured to output the operation information adjusted to the operation target.

9. An information processing system comprising:
an operating apparatus including a detection unit configured to detect an operation performed by a user; and
an information processing apparatus comprising:
an acquisition unit configured to acquire a detection result obtained by an operating apparatus and a first image in which a hand of a user is captured, the operating apparatus including a detection unit configured to detect an operation performed by the user;
a feature information generation unit configured to generate feature information regarding the hand on a basis of the first image;
an image generation unit configured to generate a second image reproducing a shape of the hand, on a basis of the detection result obtained by the detection unit and the feature information; and
a display unit configured to display the second image.

10. The information processing system according to claim 9, wherein the information processing apparatus further includes an imaging unit that includes an imaging element and that is configured to capture the first image.

11. The information processing system according to claim 10, wherein the information processing apparatus further includes an attachment unit configured to allow at least the imaging element to be attached to a body of the user.

12. The information processing system according to claim 9, wherein:
the image generation unit controls a three-dimensional model of the hand on the basis of the detection result and adjusts the three-dimensional model of the hand on the basis of the feature information, and thereby generates the second image on a basis of the three-dimensional model adjusted; and
the information processing system further comprises an operation target configured to operate on a basis of operation information based on the detection result.

13. An information processing method that is implemented by an operating apparatus that includes a detection unit and receives an operation performed by a user, the information processing method comprising:
an acquisition procedure of acquiring a first image in which a hand of the user is captured;
a feature information generation procedure of generating feature information regarding the hand on a basis of the first image; and
a feature information output procedure of outputting a detection result obtained by the detection unit and the feature information.

14. A non-transitory, computer readable storage medium containing a computer, which when executed by an information terminal connected to an operating apparatus that includes a detection unit and receives an operation performed by a user, causes the information terminal to execute actions, comprising:
acquiring a first image in which a hand of the user is captured;
generating feature information regarding the hand on a basis of the first image; and
outputting a detection result obtained by the detection unit and the feature information.
